(19) United States
(12) Patent Application Publication
(10) Pub. No.: US 2012/0000588 A1
(43) Pub. Date: Jan. 5, 2012

(54) PNEUMATIC TIRE

(75) Inventors: Atsushi Tanno, Hiratsuka-shi (JP); Ayako Jyouza, Hiratsuka-shi (JP); Shirou Ogawa, Osaka-shi (JP); Akira Fujita, Fuwa-gun (JP)

(73) Assignee: THE YOKOHAMA RUBBER CO., LTD., Tokyo (JP)

(21) Appl. No.: 13/172,166

(22) Filed: Jun. 29, 2011

(30) Foreign Application Priority Data
Jul. 5, 2010 (JP) 2010-153433

(51) Int. Cl. B60C 5/00; B60C 99/00

(52) U.S. Cl. 152/450

(57) ABSTRACT

Provided is a pneumatic tire including a hook-and-loop fastener which has a plurality of engaging elements provided at one surface of a base, in which the base of the hook-and-loop fastener is adhered to an inner surface of the tire so that the engaging elements are located near an inner cavity of the tire, and in which a protrusion is provided at one surface of the base of the hook-and-loop fastener to prevent the engaging elements from being crushed.

### CROSS-REFERENCE TO RELATED APPLICATIONS

This application is based upon and claims the benefit of priority from Japanese Patent Application No. 2010-153433, filed Jul. 5, 2010, the entire contents of which are incorporated herein by reference.

### BACKGROUND OF THE INVENTION

1. Field of the Invention

The present invention relates to a pneumatic tire of which an inner surface is provided with a hook-and-loop fastener used to attach appendages such as acoustic absorbers thereto if necessary, and more particularly, to a pneumatic tire capable of preventing an engaging element of a hook-and-loop fastener from being crushed by a pressure of a vulcanizing bladder.

2. Description of the Related Art

Hitherto, there has been proposed a pneumatic tire of which an inner surface is provided with a hook-and-loop fastener in order to easily attach appendages such as acoustic absorbers thereto, (for example, see Japanese Patent Application Laid-open No. 2006-044503). In the pneumatic tire, the acoustic absorbers are installed inside a cavity to reduce resonance generated inside the cavity. According to the pneumatic tire with the hook-and-loop fastener attached thereto, it is possible to easily attach or detach appendages such as acoustic absorbers if necessary.

However, when the pneumatic tire is vulcanized while the hook-and-loop fastener is attached to the inner surface of the tire, a problem arises in that an engaging element of the hook-and-loop fastener is crushed by a pressure of a vulcanizing bladder. Then, when the engaging element of the hook-and-loop fastener is crushed, the stability of appendages such as acoustic absorbers attached to the inner surface of the tire through the hook-and-loop fastener is degraded, and the appendages are easily separated from the attached positions when the tire runs.

### SUMMARY OF THE INVENTION

It is an object of the present invention to at least partially solve the problems in the conventional technology.

According to one aspect of the present invention, a pneumatic tire includes a hook-and-loop fastener which includes a plurality of engaging elements provided at one surface of a base, wherein the base of the hook-and-loop fastener is attached to an inner surface of the tire so that the engaging elements are located near an inner cavity of the tire, and wherein a protrusion is provided at one surface of the base of the hook-and-loop fastener to prevent the engaging elements from being crushed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a meridian half cross-sectional view illustrating a pneumatic tire according to an embodiment of the invention;

FIG. 2 is a perspective view illustrating an example of a hook-and-loop fastener used in the invention;

FIG. 3 is a perspective view illustrating another example of the hook-and-loop fastener used in the invention;

FIG. 4 is a perspective view illustrating still another example of the hook-and-loop fastener used in the invention;

FIG. 5 is a perspective view illustrating still another example of the hook-and-loop fastener used in the invention;

FIG. 6 is a perspective view illustrating still another example of the hook-and-loop fastener used in the invention;

FIG. 7 is a perspective view illustrating still another example of the hook-and-loop fastener used in the invention;

FIG. 8 is a perspective view illustrating still another example of the hook-and-loop fastener used in the invention; and

FIG. 9 is a perspective view illustrating still another example of the hook-and-loop fastener used in the invention.

### DETAILED DESCRIPTION OF THE PREFERRED EMBODIMENTS

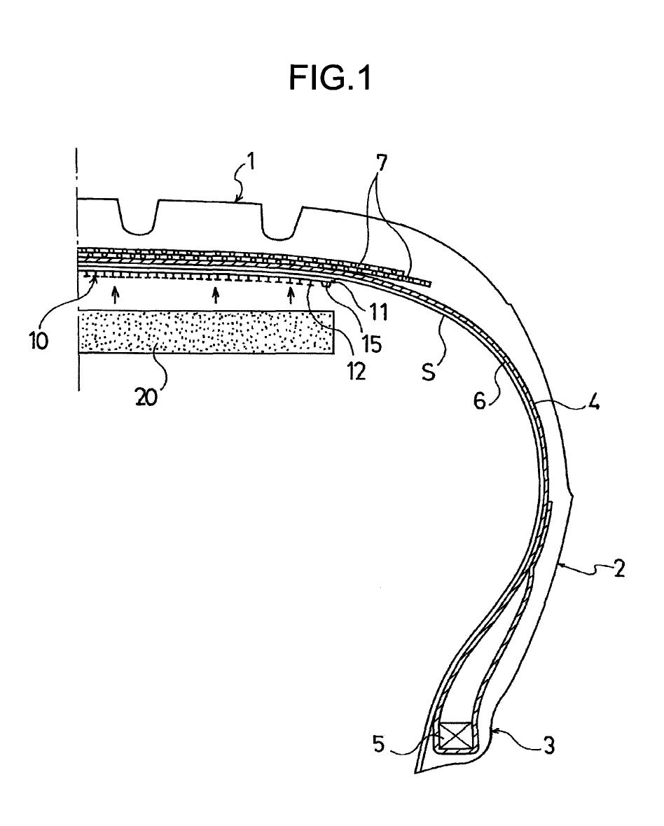

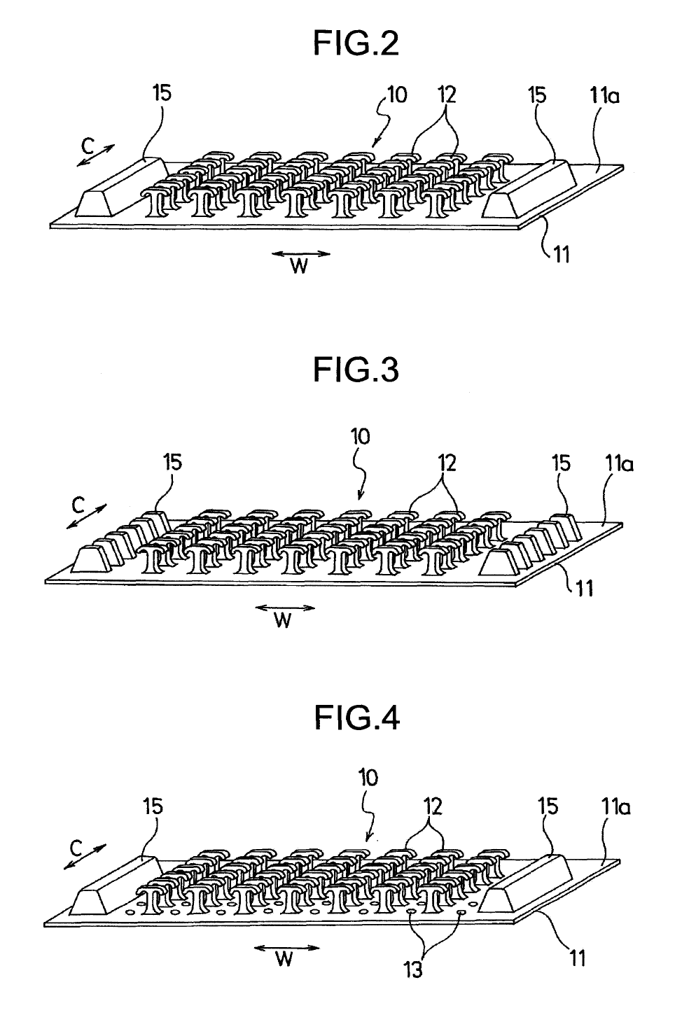

Hereinafter, the configuration of the invention will be described in detail by referring to the accompanying drawings. FIG. 1 illustrates a pneumatic tire according to an embodiment of the invention, and FIG. 2 illustrates an example of a hook-and-loop fastener used in the invention.

In FIG. 1, a tread 1, a side wall 2, and a bead 3 are illustrated. A carcass layer 4 is suspended between a pair of left and right beads 3 and 3. The carcass layer 4 is folded back from the inside of the tire to the outside thereof about a bead core 5 disposed at each bead 3. Further, an inner liner layer 6 is disposed at a portion close to an inner cavity of the tire in relation to the carcass layer 4. On the other hand, a plurality of belt layers 7 are buried in the tread 1 near the outer periphery of the carcass layer 4.

In the pneumatic tire, hook-and-loop fastener 10 is installed in an area corresponding to the tread 1 of an inner surface S of the tire. As shown in FIG. 2, the hook-and-loop fastener 10 has a structure in which a plurality of engaging elements 12 are provided at one surface 11a of a sheet-like base 11. The engaging elements 12 form a row in the tire circumferential direction C, and a plurality of rows are arranged in the tire width direction W. The shape of each engaging element 12 is not particularly limited. For example, as shown in the drawing, the engaging portion may have a T-shape of which the front end is branched to extend in the planar direction of the hook-and-loop fastener 10 or an arrowhead shape (including a two-stage arrowhead shape).

Furthermore, protrusions (ridges) 15 are provided at one surface 11a of the base 11 of the hook-and-loop fastener 10 to prevent the engaging elements 12 from being crushed. The base 11 of the hook-and-loop fastener 10 is adhered to the inner surface S of the tire through vulcanization and the engaging element 12 faces the inner cavity of the tire. However, since the hook-and-loop fastener 10 is pressed by the vulcanizing bladder when the tire is vulcanized, a pressure is exerted on the engaging element 12 in the tire radial direction. When the protrusions 15 are provided in parallel on one surface 11a of the base 11 so that the protrusions 15 receive the pressure of the vulcanizing bladder, the engaging element 12 may be prevented from being crushed. In order to prevent the engaging element 12 from being crushed, the cross-sectional area of the protrusion 15 at the center in the height direction is set to be twice or more that of the engaging element 12 at the center in the height direction.

Appendages such as acoustic absorbers 20 are attached to the hook-and-loop fastener 10 if necessary. For example, in the case of the acoustic absorber 20 made of polyurethane foam, the acoustic absorber 20 may be directly engaged with the hook-and-loop fastener 10 by using the mesh structure of the polyurethane foam. Of course, another hook-and-loop fastener capable of engaging with the hook-and-loop fastener 10 may be attached to the appendages. Examples of the appendages may include a temperature sensor, a transponder, and the like in addition to the acoustic absorber 20. Further, the installation space of the hook-and-loop fastener 10 in the inner surface S of the tire may be arbitrarily selected in accordance with the type of the appendages.

In the pneumatic tire, since the engaging element 12 and the protrusion 15 are provided at one surface 11a of the base 11 of the hook-and-loop fastener 10, the engaging element 12 of the hook-and-loop fastener 10 may be prevented from being crushed by the pressure of the vulcanizing bladder when the hook-and-loop fastener 10 is adhered by vulcanizing to the inner surface S of the tire. Accordingly, the stability of the appendages such as the acoustic absorbers 20 attached to the inner surface S of the tire through the hook-and-loop fastener 10 may improve, and the appendages may be more reliably prevented from being separated from the attached positions when the tire runs.

In the pneumatic tire, the height of the engaging element 12 from the surface of the base is not particularly limited, but may be, for example, from 0.3 mm to 5.0 mm. When the height of the engaging element 12 is set to the range, the attachment strength of the appendages such as the acoustic absorbers 20 with respect to the hook-and-loop fastener 10 may be sufficiently ensured.

On the other hand, the height of the protrusion 15 from the surface of the base may be 70% to 200% of the height of the engaging element 12 and, more preferably, 85% to 150% thereof. Accordingly, it is possible to effectively prevent the engaging element 12 from being crushed without degrading the engaging effect of the engaging element 12. When the height of the protrusion 15 is less than 70% of the height of the engaging element 12, it is not possible to effectively prevent the engaging element 12 from being crushed. On the contrary, when the height of the protrusion 15 is more than 200% of the height of the engaging element 12, the engaging effect using the engaging element 12 is degraded.

It is desirable that the protrusions 15 be disposed at a plurality of positions of the base 11 in the tire width direction and the interval between the protrusions 15 disposed at the plurality of positions in the tire width direction be from 5 mm to 70 mm and, more preferably, from 10 mm to 60 mm. Here, “the interval between the protrusions 15 in the tire width direction” refers to the shortest distance between the protrusions 15 and 15 adjacent to each other in the tire width direction. When the protrusions 15 are disposed in this manner, it is possible to effectively prevent the engaging element 12 from being crushed without degrading the engaging effect using the engaging element 12. When the interval between the protrusions 15 in the tire width direction is less than 5 mm, the engaging effect using the engaging element 12 is degraded. On the contrary, when the interval is more than 70 mm, it is not possible to effectively prevent the engaging element 12 from being crushed.

In FIG. 2, the protrusions 15 are disposed in the tire circumferential direction at two positions of the base 11 in the tire width direction, that is, both ends of the base 11 in the tire width direction. In this case, since the protrusions 15 disposed at both ends of the base 11 in the tire width direction are pressed by the vulcanizing bladder, so that the pressing force at the portion increases, both ends of the base 11 in the tire width direction may be properly adhered to the inner surface S of the tire and the adhesiveness thereof may improve.

In the pneumatic tire, the protrusions 15 may continuously extend in the tire circumferential direction or be intermittently disposed in the tire circumferential direction. Further, the shape of the protrusion 15 in the side view is not particularly limited, but may be a trapezoid, a rectangle, a semi-circle, or the like. Further, the protrusion 15 is used to prevent the engaging element 12 from being crushed, but may be provided with a hook having an engaging function.

FIGS. 3 to 9 respectively illustrate modified examples of the hook-and-loop fastener used in the invention. In FIGS. 3 to 9, the same reference numerals will be given to the same components of FIG. 2, and the detailed description thereof will not be repeated.

In FIG. 3, the hook-and-loop fastener 10 has a structure in which the plurality of engaging elements 12 and the plurality of protrusions 15 are provided at one surface 11a of the base 11. The protrusions 15 each has a trapezoid shape in the side view, and are intermittently disposed in the tire circumferential direction at both ends of the base 11 in the tire width direction.

In FIG. 4, the hook-and-loop fastener 10 has a structure in which the plurality of engaging elements 12 and the plurality of protrusions 15 are provided at one surface 11a of the base 11 and a plurality of small holes 13 are provided at the base 11 to penetrate the base 11. The protrusions 15 each has a trapezoid shape in the side view, and continuously extend in the tire circumferential direction at both ends of the base 11 in the tire width direction. The shape of each small hole 13 is not particularly limited, but may be, for example, a circle, an oval, a polygon, or the like.

Since the small holes 13 serve as ventilation passages when the tire is vulcanized because the small holes 13 are provided at the base 11 of the hook-and-loop fastener 10, it is possible to suppress air from being accumulated between the hook-and-loop fastener 10 and the inner surface S of the tire and to improve the adhesiveness of the hook-and-loop fastener 10. Furthermore, when the small holes 13 are provided at the base 11 of the hook-and-loop fastener 10, the adhesion area of the hook-and-loop fastener 10 increases, and a part of the inner liner layer 6 (the rubber layer) located at the inner surface S of the tire is vulcanized while being flown out to one surface 11a of the base 11 through the small holes 13 to exhibit an anchor effect, thereby further improving the adhesiveness of the hook-and-loop fastener 10.

The diameter of the small hole 13 may be from 0.1 mm to 1.5 mm, and the number of the small holes 13 by the unit area of 1 cm² of the base 11 may be 4 to 100. When the dimension and the density are selected, it is possible to sufficiently ensure the air accumulation suppressing effect and the adhesion area increasing effect. When the diameter of the small hole 13 is less than 0.1 mm, the rubber of the inner surface S of the tire does not easily enter the small hole 13, so that the adhesion area increasing effect and the anchor effect may not be sufficiently obtained. On the contrary, when the diameter is more than 1.5 mm, a large amount of the rubber of the inner surface S of the tire flows out from the small hole 13, so that the engaging effect using the engaging element 12 is disturbed. Further, when the number of the small holes 13 is less than 4/cm², the adhesion area increasing effect and the anchor effect may not be sufficiently obtained. On the contrary, when the number is more than 100/cm², the rigidity of the base 11 is degraded, so that there is a concern that the base 11 is distorted when the tire is vulcanized.

In FIG. 5, the hook-and-loop fastener 10 has a structure in which the plurality of engaging elements 12 and the plurality of protrusions 15 are provided at one surface 11a of the base 11. The protrusions 15 each has a semi-circular shape in the side view, and continuously extend in the tire circumferential direction at the center and both ends of the base 11 in the tire width direction.

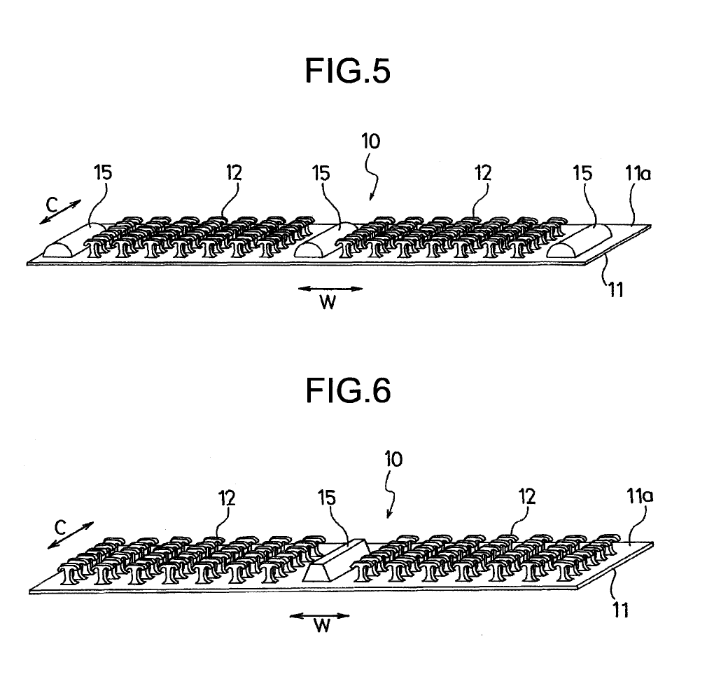

In FIG. 6, the hook-and-loop fastener 10 has a structure in which the plurality of engaging elements 12 and one protrusion 15 are provided at one surface 11a of the base 11. The protrusion 15 has a trapezoid shape in the side view, and continuously extends in the tire circumferential direction at the center of the base 11 in the tire width direction. In this case, the effect of preventing the engaging element 12 from being crushed becomes smaller than that of the structure of FIG. 2.

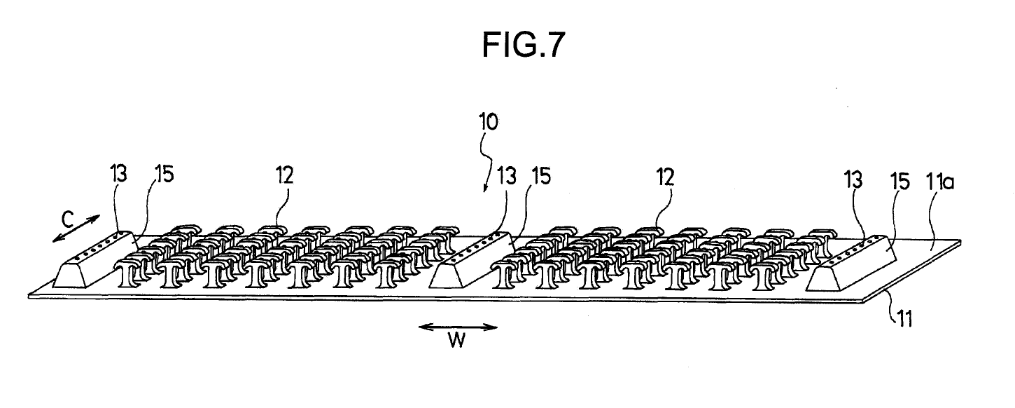

In FIG. 7, the hook-and-loop fastener 10 has a structure in which the plurality of engaging elements 12 and the plurality of protrusions 15 are provided at one surface 11a of the base 11. The protrusions 15 each has a trapezoid shape in the side view, and continuously extend in the tire circumferential direction at the center and both ends of the base 11 in the tire width direction. Further, the plurality of small holes 13 are provided at a portion provided with the protrusion 15 in the base 11 of the hook-and-loop fastener 10 to penetrate the base 11 and the protrusion 15. More specifically, the plurality of small holes 13 are disposed at each protrusion 15 in the longitudinal direction thereof.

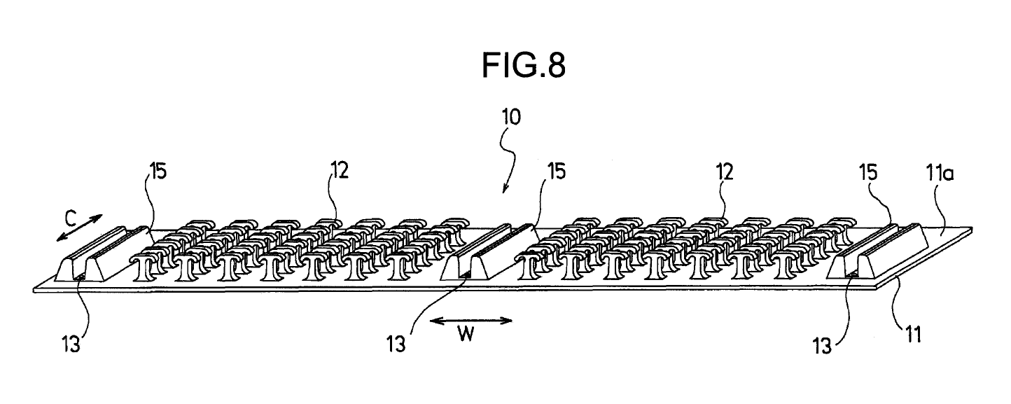

In FIG. 8, the hook-and-loop fastener 10 has a structure in which the plurality of engaging elements 12 and the plurality of protrusions 15 are provided at one surface 11a of the base 11. The protrusions 15 each has a shape in which a recess is formed at the center of the width direction, and continuously extend in the tire circumferential direction at the center and both ends of the base 11 in the tire width direction. Further, the plurality of small holes 13 are provided at a portion provided with the protrusion 15 in the base 11 of the hook-and-loop fastener 10 to penetrate the base 11 and the protrusion 15. More specifically, the plurality of small holes 13 are disposed in the recess of each protrusion 15 in the longitudinal direction thereof. In this case, the peripheral pressure of the protrusion 15 increases due to the press of the vulcanizing bladder, a larger amount of rubber flows out from the small hole 13, and the rubber is vulcanized at the recess of the protrusion 15, so that a large anchor effect is generated, thereby improving the adhesiveness of the hook-and-loop fastener 10.

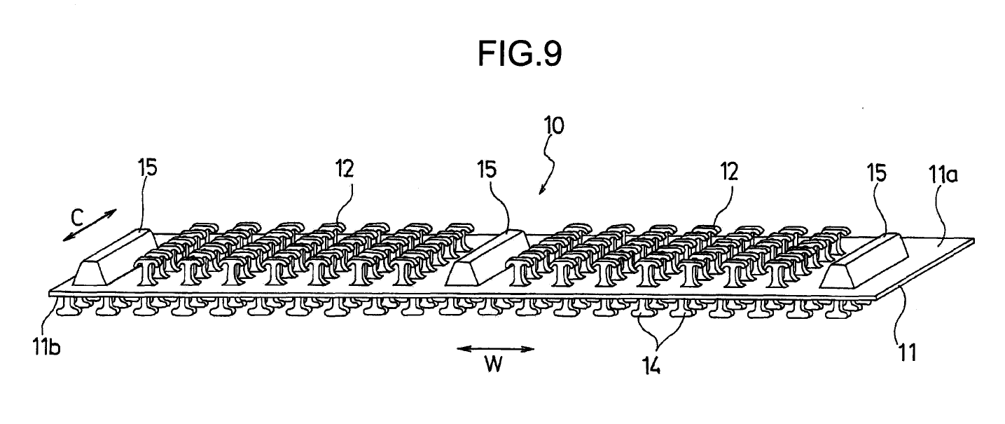

In FIG. 9, the hook-and-loop fastener 10 has a structure in which the plurality of engaging elements 12 and the plurality of protrusions 15 are provided at one surface 11a of the base 11 and a plurality of anchor elements 14 are provided at the other surface 11b of the base 11. The protrusions 15 each has a trapezoid shape in the side view, and continuously extend in the tire circumferential direction at the center and both ends of the base 11 in the tire width direction. The anchor elements 14 form a row in the circumferential direction C, and a plurality of rows are arranged in the tire width direction W. The shape of each anchor element 14 is not particularly limited, but may be, for example, a T-shape of which the front end is branched to extend in the planar direction of the hook-and-loop fastener 10 as shown in the drawing. Since the anchor elements 14 are buried in the inner liner layer 6 of the inner surface S of the tire, it is possible to improve the adhesiveness of the hook-and-loop fastener 10 with respect to the inner surface S of the tire.

The hook-and-loop fastener 10 may be molded of, for example, a thermoplastic resin such as nylon, polyester, polyethylene, polypropylene, polyvinyl chloride, polystyrene, acrylonitrile styrene, acrylonitrile butadiene styrene, and polyethylene terephthalate. For example, the hook-and-loop fastener 10 having the plurality of independent engaging elements 12 provided at one surface 11a of the base 11 may be molded as follows. A thermoplastic resin is extruded from an extruder with an opening of a shape corresponding to the shape of the base 11 and the engaging element 12 when they are seen from the tire circumferential direction. Slits are intermittently formed in the protruding portions corresponding to the engaging elements 12, and the extruded resultant is stretched to widen the gap between the engaging elements 12. Although the protrusion 15 may be integrally formed with the base 11 as in the engaging element 12, in some cases, the protrusion 15 may be attached to the base 11 after the hook-and-loop fastener 10 is extruded. Further, the protrusion 15 may be formed in a manner such that a highly viscous resin or a melted resin is applied to the surface of the base and the resultant is dried or cooled. The anchor elements 14 may be integrally formed with the base 11 as in the engaging elements 12. The small hole 13 may be formed by plastically deforming an extruded resultant obtained immediately after the extrusion or be formed by machining a hardened extruded resultant.

### Example

In a pneumatic tire with a size of P215/60 R16 having a configuration in which a hook-and-loop fastener is installed at an area corresponding to a tread in an inner surface of the tire and the hook-and-loop fastener is adhered by vulcanizing to the inner surface of the tire, engaging elements and protrusions were provided at one surface of a base of the hook-and-loop fastener and the structure of the hook-and-loop fastener was made differently as shown in Table 1. In this manner, the tires of Example 1 to Example 6 were made. Further, for comparison, the tire of Comparative Example 1 was made such that the protrusion was not provided on one surface of the base and only the engaging element was provided thereon.

Regarding these tires for test, the state of the engaging element and the adhesiveness of the hook-and-loop fastener were evaluated according to the following evaluation rule, and the result thereof is shown in Table 1.

State of engaging element: the hook-and-loop fastener adhered to the inner surface of the tire was observed in the vulcanized tires for test, and the state of the engaging element thereof was investigated. In the evaluation result, “X” indicates the case where the engaging element is noticeably crushed, and “O” indicates the case where the engaging element is not practically crushed.

Adhesiveness of hook-and-loop fastener: the vulcanized tire for test was torn down, the installation portion of the hook-and-loop fastener was cut out, a test piece with a laminated structure having the hook-and-loop fastener, the inner liner layer, and the carcass layer was manufactured, and then the adhesiveness between the tire portion (the inner liner layer and the carcass layer) and the hook-and-loop fastener of the test piece was measured on the basis of the test method according to JIS K6256-1. The evaluation result is expressed by an index in which Comparative Example 1 is set to 100. It means that the adhesiveness becomes more satisfactory as the index becomes larger.

TABLE 1

| | Comparative | Example | Example | Example | Example | Example | Example |
|---|---|---|---|---|---|---|---|
| | Example 1 | 1 | 2 | 3 | 4 | 5 | 6 |
| Structure of hook- | — | FIG. 2 | FIG. 3 | FIG. 4 | FIG. 7 | FIG. 8 | FIG. 9 |
| and-loop fastener | | | | | | | |
| State of engaging | x | ∘ | ∘ | ∘ | ∘ | ∘ | ∘ |
| element | | | | | | | |
| Adhesiveness of hook- | 100 | 106 | 104 | 126 | 116 | 120 | 130 |
| and-loop fastener | | | | | | | |

As understood from Table 1, in the tires of Example 1 to Example 6, the engaging element of the hook-and-loop fastener was not crushed and the adhesiveness of the hook-and-loop fastener was satisfactory. On the contrary, in the tire of Comparative Example 1, the engaging element of the hook-and-loop fastener was crushed.

According to one aspect of an embodiment of the present invention, in the pneumatic tire in which the base of the hook-and-loop fastener is adhered to the inner surface of the tire so that the engaging element of the base is located near the inner cavity, since the engaging element and the protrusion are provided at one surface of the base of the hook-and-loop fastener, the engaging element of the hook-and-loop fastener may be prevented from being crushed by the pressure of the vulcanizing bladder.

In one aspect of an embodiment of the present invention, it is desirable that the height of the protrusion be 70% to 200% of the height of the engaging element. Further, it is desirable that the protrusion be disposed at a plurality of positions of the base in the tire width direction and the interval between the protrusions disposed at the plurality of positions in the tire width direction be from 5 mm to 70 mm. Accordingly, the engaging element may be effectively prevented from being crushed without degrading the engaging effect using the engaging element.

It is desirable that the protrusions be disposed in the tire circumferential direction at both ends of the base in the tire width direction. Accordingly, the protrusions disposed at both ends of the base in the tire width direction are pressed by the vulcanizing bladder, so that the pressing force of the portion increases. For this reason, both ends of the base in the tire width direction may be properly adhered to the inner surface of the tire, so that the adhesiveness thereof improves.

It is desirable that a plurality of anchor elements are provided at the other surface of the base of the hook-and-loop fastener. Since these anchor elements are buried in the rubber layer of the inner surface of the tire, the adhesiveness of the hook-and-loop fastener with respect to the inner surface of the tire may improve.

It is desirable that a plurality of small holes be provided at the base of the hook-and-loop fastener to penetrate the base. In particular, it is desirable that the plurality of small holes be provided at a portion provided with the protrusion in the base of the hook-and-loop fastener to penetrate the base and the protrusion. Since these small holes serve as ventilation passages, air is prevented from being accumulated between the hook-and-loop fastener and the inner surface of the tire, so that the adhesiveness of the hook-and-loop fastener improves. In addition, when the small holes are provided as described above, the adhesion area of the hook-and-loop fastener increases, and an anchor effect is obtained by the rubber entering the small holes. For this reason, the adhesiveness of the hook-and-loop fastener may improve from this viewpoint.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A pneumatic tire comprising:
a hook-and-loop fastener which includes a plurality of engaging elements provided at one surface of a base,
wherein the base of the hook-and-loop fastener is attached to an inner surface of the tire so that the engaging elements are located near an inner cavity of the tire, and
wherein a protrusion is provided at one surface of the base of the hook-and-loop fastener to prevent the engaging elements from being crushed.

2. The pneumatic tire according to claim 1,
wherein a height of the protrusion is 70% to 200% of a height of the engaging element.

3. The pneumatic tire according to claim 1,
wherein the protrusion is disposed at a plurality of positions of the base in a tire width direction, and an interval between the protrusions disposed at the plurality of positions in the tire width direction is set to 5 mm to 70 mm.

4. The pneumatic tire according to claim 1,
wherein the protrusions are disposed along a tire circumferential direction in at least both ends of the base in the tire width direction.

5. The pneumatic tire according to claim 1,
wherein a plurality of anchor elements are provided at the other surface of the base of the hook-and-loop fastener.

6. The pneumatic tire according to claim 1,
wherein a plurality of small holes are provided in the base of the hook-and-loop fastener so as to pass through the base.

7. The pneumatic tire according to claim 1,
wherein a plurality of small holes are provided at a portion provided with the protrusions in the base of the hook-and-loop fastener so as to pass through the base and the protrusions.
